(19) United States
(12) Patent Application Publication
(10) Pub. No.: US 2005/0142326 A1
(43) Pub. Date: Jun. 30, 2005

(54) Soundproofing floor covering and method for the production thereof

(76) Inventor: Hans Rudolf Czerny, Swisttal (DE)

Correspondence Address: WILLIAM COLLARD;COLLARD & ROE, P.C., 1077 NORTHERN BOULEVARD, ROSLYN, NY, 11576, US

(21) Appl. No.: 10/519,872

(22) PCT Filed: Jun. 18, 2003
(86) PCT No.: PCT/EP03/06423

(30) Foreign Application Priority Data
Jul. 1, 2002 (DE) 102 29 524.7

(51) Int. Cl. B32B 3/02

(52) U.S. Cl. 428/95; 427/402

(57) ABSTRACT

The invention relates to a sound-insulating floor covering, in particular for motor vehicles, comprising a carpet layer (2) which on the underside comprises a base substrate (3), and a sub-layer (8, 9) which is bonded to the underside of the carpet layer by means of a hot-melt adhesive (5, 6) which is applied in multiple stages. In order to economically produce such a floor covering which is light in weight, has good sound-insulating qualities and adequate rigidity, it is proposed that directly to the base substrate of the carpet layer (2) a hot-melt adhesive (5) is applied which has an average mass flow rate of the melt ranging from 190 to 210 g/10 min and has a lower melting point than a hot-melt adhesive (6) which is applied in a subsequent stage and has an average mass flow rate of the melt ranging from 140 to 160 g/10 min. Furthermore, the second hot-melt adhesive (6) can preferably comprise hollow mineral microbodies (7). Moreover, a method for the production of such a floor covering is described.

The invention relates to a sound-insulating floor covering, in particular for motor vehicles, comprising a carpet layer which on the underside comprises a base substrate, and a sub-layer which is bonded to the underside of the carpet layer by means of a hot-melt adhesive applied in multiple stages, as well as a method for the production of such a floor covering.

Sound insulation in motor vehicles is very important in relation to driving comfort and safety because a noticeable reduction in the noise level in the interior of the vehicle means a reduction in the impairment of both concentration and performance of the driver and passengers. The driver is better able to perceive the traffic situation, and conversation in the passenger compartment is made easier.

A great number of sound insulating floor coverings for passenger motor vehicles have already been developed.

In many of these floor coverings the sound absorption performance is inadequate. While floor coverings for motor vehicles exist that provide satisfactory sound absorption performance, as a rule these floor coverings have a relatively high mass per unit area which is disadvantageous in view of the efforts made to reduce fuel consumption by reducing the vehicle's weight. Furthermore, in some known carpeting, dispersion adhesives or acrylates are used to bond the pile warp. However, these adhesives have only an inadequate stiffening effect. In contrast to this, thermoplastic adhesives can result in better stiffening but they have relatively high shrinkage values, which results in unsatisfactory flatness of a floor covering made with such adhesives.

DE 39 05 607 A1 describes a sound-insulating floor covering for motor vehicles, comprising a carpet layer and an acoustically effective layer which comprises a thermoformable absorbent plastic material that can be made into a foam, as well as a layer comprising a nonwoven fibre fabric. The carpet layer of this floor covering comprises a support layer into which the pile or filament is inserted by tufting. A coating of hot-melt or latex is applied for affixing the filament. For the purpose of bonding the following acoustically effective layer, polyethylene powder is sintered onto the filament fixation layer. The acoustically effective layer is followed by a foamed-on backing. As an alternative, an additional laminated-on nonwoven sealant fabric or a heavy layer can be arranged between the acoustically effective layer and the foamed-on backing. The production of this known floor covering is relatively expensive.

It is the object of the present invention to produce a sound-insulating floor covering of the type mentioned in the introduction, which floor covering is light in weight, has good sound-insulating qualities, adequate rigidity, low shrinkage values and is economical to produce. Furthermore, a method for producing such a floor covering is to be stated.

This object is met by a floor covering having the features of claim 1 and by a method having the features of claim 10 respectively. Preferred and advantageous embodiments of the invention are stated in the subordinate claims.

The floor covering according to the invention essentially comprises a carpet layer comprising a base substrate and a sub-layer which has been bonded to the underside of the carpet layer by a hot-melt adhesive applied in multiple stages, wherein directly to the base substrate of the carpet layer a hot-melt adhesive is applied which has an average mass flow rate of the melt ranging from 190 to 210 g/10 min, preferably approximately 200 g/10 min and has a lower melting point than a hot-melt adhesive applied in a subsequent stage, which adhesive has an average mass flow rate of the melt ranging from 140 to 160 g/10 min, preferably of approximately 150 g/10 min.

The floor covering according to the invention features a good connection between the fibre material of the carpet layer and the acoustically effective backing which is preferably made from a lightweight absorbent material. A carpet layer with a particularly lightweight backing is achieved which shows no warping or shrinkage so that the carpet lies nice and flat. Furthermore, the floor covering according to the invention has good rigidity and dimensional stability.

The hot-melt adhesive used is preferably in powdered form, for example an EVA or LD-PE hot-melt adhesive. As a result of the comparatively high mass flow rate of the melt and the comparatively low melting point of the first-applied hot-melt adhesive, an excellent wear-resistant pile fibre connection to the base substrate of the carpet layer is achieved.

An advantageous embodiment of the floor covering according to the invention consists in that the base substrate of the carpet layer is a woven fabric, knitted fabric or nonwoven fabric, wherein the hot-melt adhesive which is applied directly to the base substrate, and the hot-melt adhesive applied in the subsequent stage form an adhesive layer which comprises a multitude of gaps which define fluid-permeable passages. In this way the sound-absorption performance of the floor covering according to the invention is improved. By way of the permeable carpet layer and the gaps present in the adhesive layer, sound waves can penetrate right into the sound-absorbent sub-layer.

The sound-insulating sub-layer of the floor covering according to the invention preferably comprises a layer of nonwoven fibre fabric, in particular from a mixed PET/PP/PET nonwoven fibre fabric, and/or a heavy layer, in particular a foamed heavy layer.

Another advantageous embodiment of the floor covering according to the invention consists in that, preferably in the second hot-melt adhesive, mineral microbodies and/or hollow mineral microbodies, for example hollow glass spherules or hollow ceramic spherules, are contained. Such hollow bodies are light in weight and increase the strength and rigidity of the floor covering, respectively. Hollow mineral microbodies are to be preferred because they are particularly light in weight and provide particularly good thermal and sound insulation.

Furthermore, the dimensional stability and rigidity of the floor covering according to the invention can be increased by crosslinking additives which are preferably added to the hot-melt adhesive applied in the subsequent stage. Preferably, these additives are melamine resin powder. Melamine resin features good temperature resistance and in addition provides a certain flame-retardant effect.

A further advantageous embodiment of the floor covering according to the invention consists in that the hot-melt adhesive which is applied in the subsequent stage comprises a flame retardant. Preferably aluminium hydroxide powder and/or magnesium hydroxide powder is used as a flame retardant.

Further preferred and advantageous embodiments of the invention are disclosed in the subordinate claims.

Below, the invention is explained in detail with reference to a drawing which shows one embodiment. The following are diagrammatically shown:

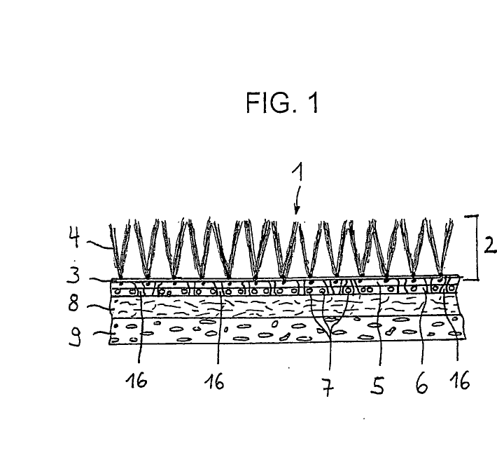

FIG. 1 a cross section (not to scale) of a floor covering according to the invention; and

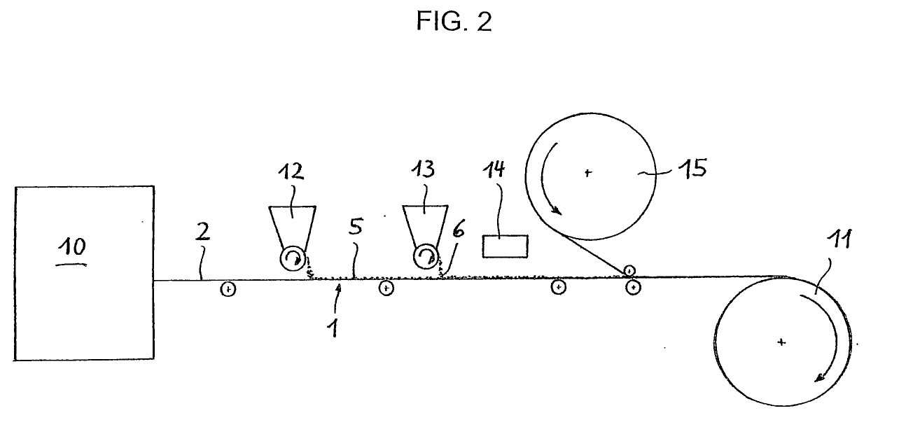

FIG. 2 the basic design of a facility for producing the floor covering according to the invention.

The visible surface 1 of the floor covering shown in FIG. 1 comprises a carpet layer 2 with a base substrate 3, into which the pile warp 4 is drawn by means of a multineedle machine. Later on, the pile warp is cut open so that a velour carpet results. The base substrate 3 of the carpet layer 2 is permeable to sound waves. It can for example consist of a woven, knitted or nonwoven support fabric. Preferably the base substrate 3 is a spunbonded nonwoven fabric.

A hot-melt adhesive 5 is applied directly to the textile underside of the carpet layer 2, which adhesive is preferably a hot-melt adhesive based on ethylene vinyl acetate (EVA) or low-density polyethylene (PE-LD). The hot-melt adhesive 5 is applied at a quantity of approximately 50 g/m².

A second hot-melt adhesive 6 is applied to this first-applied hot-melt adhesive. This second hot-melt adhesive, too, can be an EVA or PE-LD adhesive. It is applied at a rate of approximately 150 g/m².

The first-applied hot-melt adhesive 5 has an average mass flow rate of the melt of 190 to 210 g/10 min, preferably of approximately 200 g/10 min, and a lower melting point than the hot-melt adhesive 6 which is applied subsequently and which has an average mass flow rate of the melt of 140 to 160 g/10 min, preferably of approximately 150 g/10 min. Sometimes the mass flow rate (MFR) is also referred to as the melt-flow index (MFI). It describes the flow behaviour of a melt and is defined in ISO 1133 as well as in ASTM D 1238. Of course, the values of the mass flow rates applying to the two hot-melt adhesives 5 and 6 were determined under identical conditions, i.e. at identical pressure and identical temperature, namely at normal pressure 101325 Pa (=1.01325 bar) and 190° C.

It can be seen from the illustration that the hot-melt adhesive 5 and the subsequently applied hot-melt adhesive 6 form an adhesive layer which comprises a multitude of gaps or recesses 16 which define fluid-permeable passages.

The hot-melt adhesive 5 and 6 thus predominantly binds to the pile fibres or pile knots of the carpet layer, where it forms a type of net. The last-applied hot-melt adhesive 6 contains hollow mineral microbodies 7, e.g. in the form of hollow glass spherules or hollow ceramic spherules. The hollow glass spherules or hollow ceramic spherules stiffen the floor covering and also have a remarkably sound-insulating effect.

According to a preferred variant, the hot-melt adhesive 6 can also comprise a duroplastically crosslinking additive and/or a flame retardant. Preferably, melamine resin powder is used as the duroplastically crosslinking additive. Preferably aluminium hydroxide powder with a granular size of ≧150 μm and/or a correspondingly fine magnesium hydroxide powder are/is used as a flame-retarding additive.

As an alternative or in addition to the hollow mineral microbodies 7, the hot-melt adhesive 6 can also contain particles which expand under the effect of heat or fire. The particles comprise small hollow plastic particles which comprise a gas-proof envelope of a mixed polymer, which envelope is insoluble in water and which encapsulates liquid and/or gaseous hydrocarbon. The hollow plastic particles have a grain diameter ranging from approx. 2 to 50 μm, preferably 10 to 20 μm. If the hollow plastic particles are heated up as a result of the effect of heat or fire, the liquid hydrocarbon changes to the gas phase. As the temperature rises, the pressure of the gaseous hydrocarbon increases. At the same time, the gas-proof envelope softens so that the volume of the hollow plastic particles increases to many times its former value. For example, the volume increase can be 30 to 50 times the original volume. The material of the gas-proof envelope and the hydrocarbon enclosed therein are selected such that the volume increase (expansion) is triggered with the effect of heat from a certain temperature range onward. The trigger temperature is preferably in excess of 100° C. In a particular temperature range the envelope is so soft that it will finally burst if the temperature continues to increase, thus releasing the encapsulated hydrocarbon as a propellant gas. The temperature range in which the propellant gas is released is above approximately 130° C.

An acoustically effective sub-layer in the form of a layer of nonwoven fibre fabric 8 is next to the adhesive layer. Finally, a foamed heavy layer 9 is next to the layer of nonwoven fibre fabric 8. The layer of nonwoven fibre fabric 8 preferably comprises a mixed PET/PP/PET nonwoven fibre fabric or spun fibre fabric. It is also within the scope of the invention to leave out the heavy layer 9 or the nonwoven fibre fabric 8.

FIG. 2 shows the production of the floor covering according to the invention. Reference number 10 designates a production plant in which the carpet layer 2 with a base substrate comprising a woven fabric, knitted fabric or nonwoven fabric is generated as continuous fabric. From the production plant 10, the carpet layer or carpet line 2 is transported, by way of supporting rollers, to a reeling device 11, wherein the visible side 1 of the carpet points downward and the base substrate points upward.

Above the carpet line 2, two heads 12, 13 for scattering powder are arranged, spaced apart from each other in the direction of transport, which heads 12, 13 are used for applying powdered hot-melt adhesive. The head 12 for scattering powder is set in such a way in relation to the transport speed of the carpet line 2 that it applies powdered hot-melt adhesive at a rate of approx. 50 g/m² directly to the base substrate of the carpet layer 2. In contrast, the head 13 for scattering powder, which head follows in the direction of transport, is set in such a way that it applies powdered hot-melt adhesive 6 at a rate of approximately 150 g/m² to the first layer 5 of hot-melt adhesive. The powdered hot-melt adhesive comprises the above-mentioned hollow microbodies 7 and if required one or several of the above-mentioned additives.

Downstream of the head 13 for scattering powder, when viewed in the direction of transport of the carpet line 2, there is a heater 14, for example in the form of an infrared radiator, by means of which heater both powdered hot-melt adhesives 5 and 6 are melted on together. Subsequently, at least one continuous line of nonwoven fibre fabric and/or heavy layer, which are/is reeled off a supply roll 15, is laminated onto the reverse side of the carpet line 2, which comprises the melted adhesive. Furthermore, for faster solidification of the adhesive, a cooling device (not shown) can be provided.

The hot-melt adhesive 5 and the hot-melt adhesive 6 applied in the subsequent stage are set and applied in such a way that after their melting-on and their solidification a net-like adhesive layer results which comprises a multitude of gaps or recesses which define fluid-permeable locations.

Implementation of the invention is not limited to the embodiment described above. Rather, a number of variants are possible which, even if their design basically differs, make use of the inventive idea defined in the claims. For example, the first-applied powdered hot-melt adhesive 5 can be melted on already prior to the application of the second powdered hot-melt adhesive 6 by means of an additional heater (not shown) arranged upstream of the head 13 for scattering powder.

1. A sound-insulating floor covering, in particular for motor vehicles, comprising a carpet layer (2) which on the underside comprises a base substrate (3), and a sub-layer (8, 9) which is bonded to the underside of the carpet layer by means of a hot-melt adhesive (5, 6) applied in multiple stages, wherein
directly to the base substrate of the carpet layer (2) a hot-melt adhesive (5) is applied which has an average mass flow rate of the melt ranging from 190 to 210 g/10 min and has a lower melting point than a hot-melt adhesive (6) which is applied in a subsequent stage and which has an average mass flow rate of the melt ranging from 140 to 160 g/10 min.

2. The floor covering according to claim 1, wherein
the hot-melt adhesive (5) which is applied directly to the base substrate (3) of the carpet layer (2) is applied at a lower mass per unit area than the hot-melt adhesive (6) which is applied in the subsequent stage.

3. The floor covering according to claim 1, wherein
at least one of the hot-melt adhesives (5, 6) comprises mineral microbodies and/or hollow mineral microbodies (7).

4. The floor covering according to claim 1 or 2, wherein
the hot-melt adhesive (6) which is applied in the subsequent stage comprises mineral microbodies and/or hollow mineral microbodies (7).

5. The floor covering according to claim 1, wherein
the base substrate (3) is a woven fabric, knitted fabric or nonwoven fabric, wherein the hot-melt adhesive (5) which is applied directly to the base substrate (3), and the hot-melt adhesive (6) which is applied in the subsequent stage form an adhesive layer which comprises a multitude of gaps (16) which define fluid-permeable passages.

6. The floor covering according to claim 1, wherein
the sub-layer comprises a layer of nonwoven fibre fabric (8) and/or a heavy layer (9).

7. The floor covering according to claim 1, wherein
the hot-melt adhesive (6) which is applied in the subsequent stage comprises one or several crosslinking additives.

8. The floor covering according to claim 1, wherein
the hot-melt adhesive (6) which is applied in the subsequent stage comprises a flame retardant.

9. The floor covering according to claim 1, wherein
the hot-melt adhesive (6) which is applied in the subsequent stage comprises particles which expand under the effect of heat.

10. A method for producing a floor covering according to claim 1, in which in several stages hot-melt adhesive (5, 6) is applied to the backing of a carpet layer (2) which on the underside comprises a textile base layer (3), and a sound-insulating sub-layer (8, 9) is applied to the hot-melt adhesive, wherein
a hot-melt adhesive (5) is applied directly to the base layer (3) of the carpet layer (2), which hot-melt adhesive (5) has an average mass flow rate of the melt ranging from 190 to 210 g/10 min, and a lower melting point than a hot-melt adhesive (6) which is applied in a subsequent stage and which has an average mass flow rate of the melt ranging from 140 to 160 g/10 min.

11. The method according to claim 10, wherein
the hot-melt adhesive (5) which is applied in the first stage is applied at a lower mass per unit area than the hot-melt adhesive (6) which is applied in the subsequent stage.

12. The method according to claim 10, wherein
the hot-melt adhesive (5) which is applied directly to the base layer (3) of the carpet layer (2) and the hot-melt adhesive (6) which is applied in the subsequent stage are each scattered-on in the form of powdered hot-melt adhesive, and are melted-on prior to the application of the sound-absorbent sub-layer, either together or spaced apart in time.

13. The method according to claim 10, wherein
mineral microbodies and/or hollow mineral microbodies (7) are added to the hot-melt adhesive (6) which is applied in the subsequent stage.

14. The method according to claim 10, wherein
a woven fabric, knitted fabric or nonwoven fabric is used as the base substrate (3), and the hot-melt adhesive (5) which is applied directly to the base substrate (3) of the carpet layer (2) and the hot-melt adhesive (6) which is applied in the subsequent stage are applied such that after solidification of the hot-melt adhesives (5, 6) an adhesive layer is formed which comprises a multitude of gaps which define fluid-permeable passages.

15. The method according to claim 10, wherein
a layer of nonwoven fibre fabric (8) and/or a heavy layer (9) are/is applied as a sound-absorbent sub-layer.

16. The method according to claim 10, wherein
a crosslinking additive is added to the hot-melt adhesive (6) which is applied in the subsequent stage.

17. The method according to claim 10, wherein
a flame retardant is added to the hot-melt adhesive (6) which is applied in the subsequent stage.

18. The method according to claim 10, wherein
particles which expand under the effect of heat are added to the hot-melt adhesive (6) which is applied in the subsequent stage.
